(19) United States
(12) Patent Application Publication
(10) Pub. No.: US 2010/0091326 A1
(43) Pub. Date: Apr. 15, 2010

(54) Printing System, and Printing Method and Recording Medium

(75) Inventor: Kazuhito GASSHO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/573,471

(22) Filed: Oct. 5, 2009

(30) Foreign Application Priority Data
Oct. 9, 2008 (JP) 2008-262721

(51) Int. Cl. G06F 3/12

(52) U.S. Cl. 358/1.15

(57) ABSTRACT

A printing system is provided which includes a printer, a job control section that supplies print job data to the printer, and a determination section that determines whether to execute printing of the print job data. In the printing system, the job control section generates determination information, which is information relating to printing the print job data, before the print job data are supplied to the printer. In the printing system, the determination section determines whether to execute printing of the print job data depending on the determination information and information relating to the status of the printer. In the printing system, the job control section supplies the print job data to the printer, when the determination result shows that the printing is possible.

### BACKGROUND

1. Technical Field

The present invention relates to a printing system and a printing method.

2. Related Art

A technology is known which reports the future respective remaining amounts of recording materials of plural colors, and reports a message giving processing instructions. In addition, regarding a print job self-transmitted for an image printer by a personal computer, a technology is also known which predicts whether the print job can be executed on the basis of resource information of the image printer, and the print conditions of the previously-accumulated preceding print job(s) (see, Japanese Patent No. 3,360,728 and JP-A-2007-328494).

However, a variety of drawbacks have occurred in the case of determining whether to execute printing and advancing the printing. For example, high-capacity memory may have been required of printers in order to store print data having the possibility of not being printed.

### SUMMARY

An advantage of some aspects of the invention is to prevent drawbacks from occurring by determining whether to execute printing and advancing the printing.

According to a first aspect of the invention, a printing system is provided which includes a printer, a job control section that supplies print job data to the printer, and a determination section that determines whether to execute printing of the print job data. In the printing system, the job control section generates determination information, which is information relating to printing of the print job data, before the print job data are supplied to the printer. In the printing system, the determination section determines whether to execute printing of the print job data depending on the determination information and information relating to the status of the printer. In the printing system, the job control section supplies the print job data to the printer, when the determination result shows that the printing is possible.

With this configuration, whether to execute printing of the print job data is determined depending on the determination information, before the print job data are supplied to the printer. Therefore, it is possible to prevent drawbacks from occurring by determining whether to execute printing and advancing the printing.

It is preferable that the job control section includes a printer driver that generates the print job data and the determination information corresponding to the print job data.

With this configuration, the printer driver generating the print job data generates the determination information corresponding to the print job data. Therefore, it is possible to prevent the configuration of the system from becoming excessively complex.

It is preferable that the job control section includes a spooler that temporarily stores the print job data, and a determination information generation section that generates the determination information by analyzing the print job data stored in the spooler.

With this configuration, the determination information is generated by analysis of the print job data stored in the spooler. Therefore, it is possible to generate the determination information appropriately.

It is preferable that the printing system further includes a job control device which is connected to the printer and has the job control section. The determination section is provided in the printer. The job control section transmits the determination information to the printer. The determination section transmits the determination result to the job control device.

With this configuration, it is possible to prevent drawbacks from occurring by determining whether to execute printing and advancing the printing, when the printing system using the printer and the job control device is employed.

It is preferable that the determination information includes at least one of (1) an expected amount to be used of printing papers required for the printing, (2) an expected amount to be used of a recording material required for the printing, and (3) an expected amount to be used of a memory required for the printing.

With this configuration, it is possible to prevent drawbacks from occurring, in the case of determining whether to execute printing by using at least one of the number of the printing papers, the expected amount to be used of the recording material, and the expected amount to be used of the memory.

It is preferable that the information relating to the status of the printer includes at least one of (1) the remaining amount of the printing papers used in the printing, (2) the remaining amount of the recording material used in the printing, and (3) the free space of the memory used in the printing.

With this configuration, it is possible to prevent drawbacks from occurring, in the case of determining whether to execute printing by using at least one of the remaining amount of the printing papers, the remaining amount of the recording material, and the free space of the memory.

It is preferable that the printing system further includes a plurality of client devices. The job control section responds to each print request from the plurality of client devices, and performs generation of the determination information for print job data responding to the print request and supply of the print job data responding to the determination result.

With this configuration, it is possible to prevent drawbacks from occurring, in the case of using the printing system which performs processing in response to each print request from a plurality of client devices.

It is preferable that the job control section performs processing for notifying a user of the determination result without supplying the print job data to the printer, when the determination result shows that the printing is not possible.

With this configuration, when the determination result shows that the printing is not possible, the print job data is not supplied to the printer. Therefore, it is possible to suppress print errors in the printer. Further, since a user is notified of the determination result, the user can easily confirm that the printing is stopped.

According to a second aspect of the invention, provided is a printing method, including: generating determination information, which is information relating to printing print job data, by a job control section, before the print job data are supplied to a printer; determining whether to execute printing of the print job data by a determination section depending on the determination information and information relating to the status of the printer; and supplying the print job data to the printer by the job control section, when the determination result shows that the printing is possible.

In addition, the invention can implement a variety of embodiments. For example, they can be realized by a printing method and apparatus, a computer program for implementing functions of the method or apparatus, and a recording medium having the computer program recorded, or the like.

### BRIEF DESCRIPTION OF THE DRAWINGS

The invention will be described with reference to the accompanying drawings, wherein like numbers reference like elements.

FIG. 1 is an illustrative diagram showing a printing system used as an embodiment of the invention.

FIG. 2 is a block diagram showing the function of the printing system.

FIG. 3 is a sequence diagram of print processing which makes use of the prior determination.

FIG. 4 is an illustrative diagram showing the printing determination which makes use of determination information and resource information.

FIG. 5 is an illustrative diagram showing a window for notifying a user of the determination result DR.

FIG. 6 is an illustrative diagram showing an operation example of the printing system.

FIG. 7 is an illustrative diagram showing another operation example of the printing system.

FIG. 8 is an illustrative diagram showing another embodiment of the printing system.

FIG. 9 is a block diagram showing the function of a printing system of the embodiment.

FIG. 10 is an illustrative diagram showing an operation example of the printing system.

FIG. 11 is an illustrative diagram showing another operation example of the printing system.

### DESCRIPTION OF EXEMPLARY EMBODIMENTS

Next, the invention will be described in the order mentioned below on the basis of the embodiments.

### A. First Embodiment

### B. Second Embodiment

### C. Modified Example

### A. First Embodiment

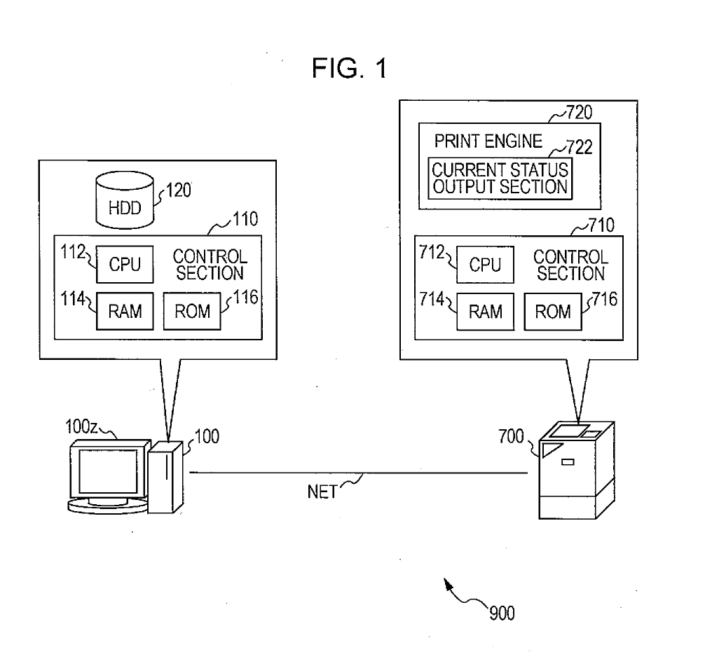

FIG. 1 is an illustrative diagram showing a printing system 900 used as an embodiment of the invention. This printing system 900 includes a personal computer 100 (hereinafter, simply also referred to as “computer 100” or “client device 100”) and a printer 700. The computer 100 and the printer 700 can communicate with each other via a network NET.

The computer 100 includes a control section 110 and a hard disk drive 120. The control section 110 includes a CPU 112, RAM 114, and ROM 116. The CPU 112 fulfils a variety of functions by executing programs.

A display device 100z is connected to the computer 100. The display device 100z displays a variety of information including manipulation menus or images in accordance with instructions from the control section 110. The display device 100z can adopt a variety of display devices such as a liquid crystal display or an organic EL display and the like.

In addition, although not shown in the drawings, input devices receiving instructions of a user are also connected to the computer 100. The input devices can adopt, for example, a keyboard, a mouse, or a touch panel.

The printer 700 includes a control section 710 and a print engine 720. The control section 710 controls the print engine 720. The control section 710 is a computer including a CPU 712, a RAM 714, and a ROM 716. The print engine 720 is a print mechanism which executes a print operation using provided print data. The print mechanism may include a variety of print mechanisms. For example, the print mechanism includes a print mechanism which discharges ink drops to a printing paper to form an image, or a print mechanism which transfers/fixes toner onto a printing paper to form an image, and the like. In the embodiment, the print engine 720 executes a print operation using toner and a photoconductive drum.

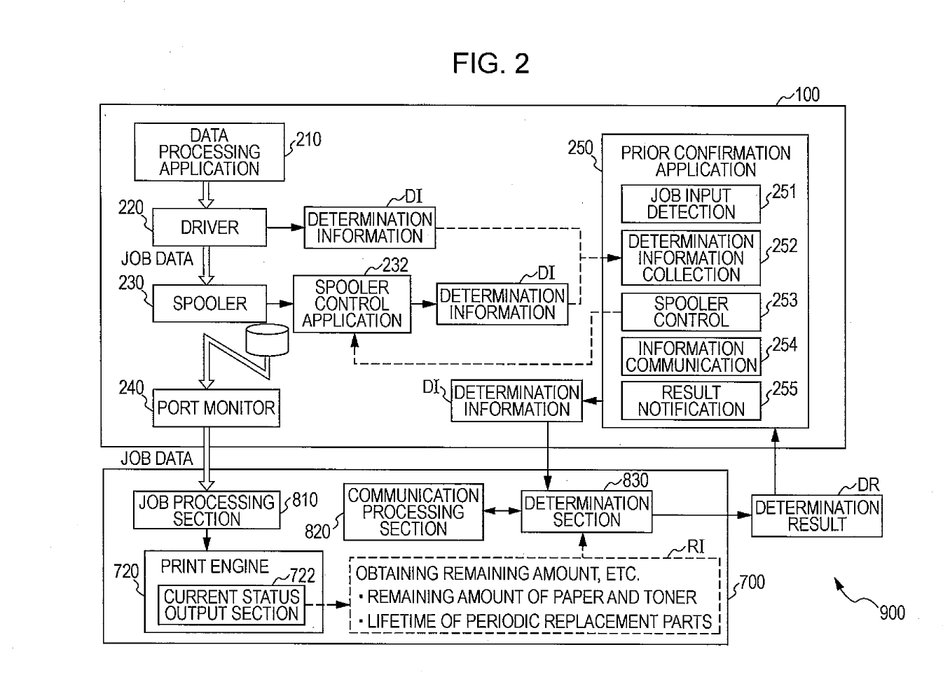

FIG. 2 is a block diagram showing the function of the printing system 900. In the computer 100, a data processing application 210, a printer driver 220, a spooler 230, a spooler control application 232, a port monitor 240, and a prior confirmation application 250 are operating (hereinafter, the spooler control application 232 is also referred to as a “spooler controller 232”. Further, the printer driver 220 is also simply referred to as a “driver 220”).

The spooler 230 is a memory which temporarily stores the print job data described below. In the embodiment of FIG. 2, a portion of a storage area of the hard disk drive 120 (FIG. 1) is used as the spooler 230.

The data processing application 210, the driver 220, the spooler controller 232, the port monitor 240, and the prior confirmation application 250 are programs (program modules) executed by the CPU 112 (FIG. 1). Hereinafter, operations that the CPU executes processing for in accordance with the program modules are also simply represented as “operations that the module executes processing for”. Each of the modules 210, 220, 232, 240, and 250 can transmit and receive data to each other via the RAM 114.

The data processing application 210 is a variety of data processing applications such as an image processing application or a document preparation application. The data processing application 210 executes data processing in accordance with instructions of a user. In addition, the data processing application 210 supplies data, which represent an image to be printed, to the driver 220 in accordance with print instructions of a user.

The driver 220 generates the print job data representing a print job in accordance with data from the data processing application 210 (hereinafter, simply referred to as “job data”). The job data are print data representing a print image. As such job data formats, a variety of formats can be adopted. For example, PDL data, which are described by PDL (Page Description Language) based on the printer 700, may be adopted. Furthermore, data which are expressed by predetermined draw commands may be adopted (for example, so-called EMF (Enhanced Meta File) data can be adopted as such data). Even in any case, arbitrary formats which are available to the printer 700 (job processing section 810) can be adopted as the job data formats.

The driver 220 stores the generated job data in the spooler 230. The spooler controller 232 transmits the job data stored in the spooler 230 to the printer 700. Transmission of the job data is controlled by the port monitor 240. The port monitor 240 transmits the job data to the printer 700 using a connection interface (not shown) connected to the printer 700 (network NET (FIG. 1)).

In the printer 700, the job processing section 810, a communication processing section 820, a determination section 830, and the print engine 720 are operating. The job processing section 810, the communication processing section 820, and the determination section 830 are programs (program modules) executed by the CPU 712 (FIG. 1). Each of the modules 810, 820, and 830 can transmit and receive data to each other via the RAM 714.

The job processing section 810 controls the print engine 720 in accordance with the job data received from the computer 100 (supplies print data to the print engine 720). Herewith, an image represented by the job data is printed. In the embodiment, a predetermined portion of the storage area of the RAM 714 (FIG. 1) is employed as a buffer memory which temporarily stores data used in printing. Data stored in the buffer memory are not limited to the job data, but include a variety of data (for example, dot pattern data generated from job data) used in printing.

The print engine 720 includes a current status output section 722. The current status output section 722 supplies resource information RI of the printer 700 to the determination section 830. The resource information RI represents the current status of resources available to the printer 700. The detailed resource information RI will be described later.

In addition, the prior confirmation application 250 of the computer 100 supplies the determination information DI to the determination section 830. The determination information DI is information related to the job data printing. The detailed determination information DI will be described later. Furthermore, the prior confirmation application 250 includes a first function 251 detecting print job input, a second function 252 collecting the determination information, a third function 253 controlling the spooler, a fourth function 254 performing information communication, and a fifth function 255 notifying determination results.

The determination section 830 determines whether to execute printing by using the resource information RI and the determination information DI (hereinafter, this determination is also referred to as “printing determination”). This printing determination is performed before the job data are supplied from the computer 100 to the printer 700. The prior confirmation application 250 determines whether to supply the job data to the printer 700 in accordance with the result DR of this printing determination.

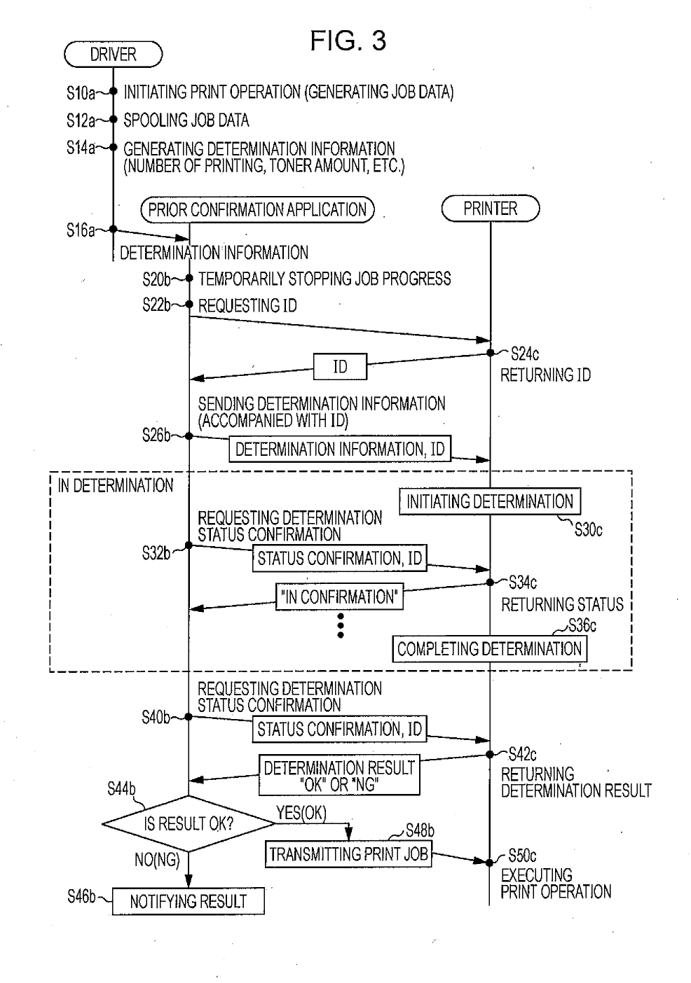

FIG. 3 is a sequence diagram of print processing which makes use of the prior determination. In an initial step S10a, the driver 220 (FIG. 2) generates the job data in response to a request of the data processing application 210. In a next step S12a, the driver 220 stores generated the job data in the spooler 230. In the next step S14a, the driver 220 generates the determination information DI by analyzing generated the job data.

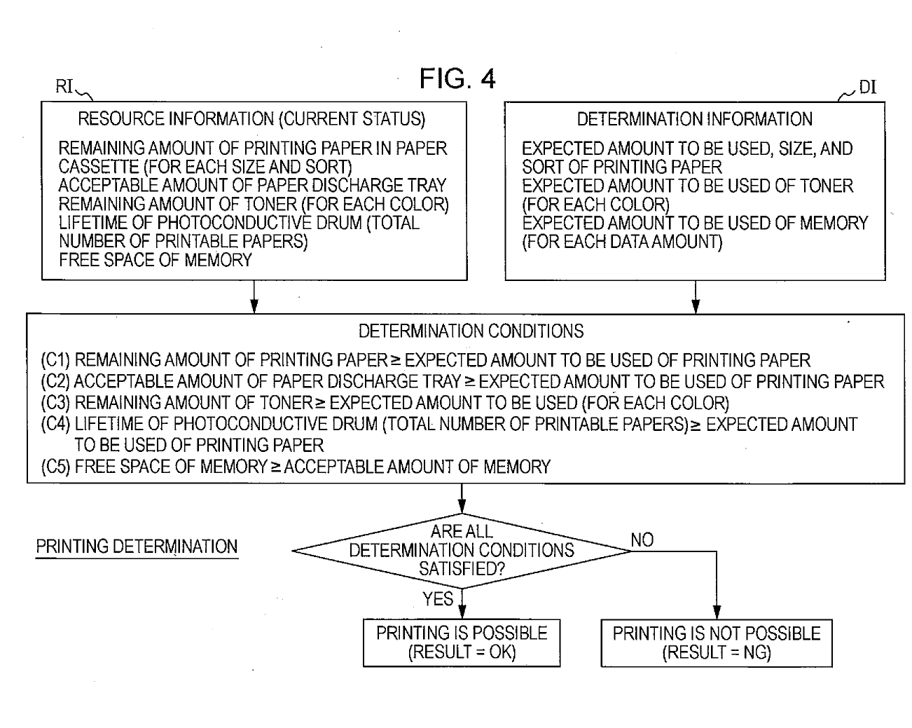

FIG. 4 is an illustrative diagram showing the printing determination which makes use of determination information DI and resource information RI. In the drawing, the determination information DI and the resource information RI are shown. In the embodiment, the determination information DI includes information mentioned below:

(1) the expected amount to be used, the size, and the sort of the printing paper required for printing;
(2) the expected amount to be used of toner required for printing; and
(3) the expected amount to be used of memory required for printing.

The expected amount to be used of the printing paper represents the total number required for printing in accordance with the job data. The size and the sort of the printing paper are each designated by instructions of a user with respect to the data processing application 210 (FIG. 2). The size is selected among a plurality of options prepared previously (for example, “A4” and “B5”). The sort is selected among a plurality of options prepared previously (for example, “plain paper” and “glossy paper”).

The expected amount to be used of toner required for printing is calculated for each toner color (that is, for each sort of available toner). A variety of methods can be adopted as the method of calculating the toner amount (expected amount to be used). For example, the toner amount may be calculated from the colors of each pixel of the print image. In addition, the toner amount may be calculated by using the dot count corresponding to the colors of each pixel.

The expected amount to be used of the memory required for printing represents the memory amount required for printing using the job data. As the memory amount, for example, the size of the job data can be adopted. Further, when dot pattern data are generated from the job data in the printer 700, the sum of the size of the job data and the size of dot pattern data can be adopted. This memory amount (data size) may be estimated from data representing the print image (for example, color data or draw commands).

In the next step S16a of FIG. 3, the driver 220 (FIG. 2) supplies the determination information DI to the prior confirmation application 250. Here, the driver 220 may supply the determination information DI to the prior confirmation application 250 automatically in accordance with the generation of the job data. Further, the prior confirmation application 250 may request the determination information DI from the driver 220 in accordance with detecting the print job input (first function 251 and second function 252).

In the next step S20b, the prior confirmation application 250 (FIG. 2) temporarily stops the advance of the print job. In the embodiment, the prior confirmation application 250 supplies instructions for withholding transmission of the job data to the spooler controller 232 (third function 253). The spooler controller 232 withholds transmission of the job, data stored in the spooler 230 in accordance with instructions.

In the next step S22b, the prior confirmation application 250 (FIG. 2) requests an identifier unique to the print job (hereinafter, simply referred to as a “job ID”) from the printer 700. In a next step S24c, the determination section 830 returns the job ID to the computer 100 in response to the request. As the job ID, a variety of values can be adopted. For example, an ID used in communications between the computer 100 and the printer 700 may be employed as the job ID. Further, the determination section 830 may determine the job ID by a predetermined method in response to the request for the job ID.

In the next step S26b, the prior confirmation application 250 (FIG. 2) request the printing determination from the printer 700. The prior confirmation application 250 transmits the determination information DI and the job ID to the printer 700 according to this request. In the next step S30c, the determination section 830 initiates the determination in response to the received request.

The determination section 830 (FIG. 2) requests the current resource information RI from the current status output section 722 in order to make a determination. The current status output section 722 supplies the resource information RI to the determination section 830 in response to the request. In FIG. 4, the resource information RI is shown. The resource information RI includes data mentioned below:

(1) the remaining amount of the printing papers in the paper cassette;
(2) the acceptable amount of the paper discharge tray;
(3) the remaining amount of toner;
(4) the lifetime of the photoconductive drum; and
(5) the free space of the buffer memory.

As a method in which the current status output section 722 specifies each data described above, an arbitrary method can be adopted. For example, for specifying the remaining amount of the printing papers, a user inputs the remaining amount of the printing papers to the printer 700 in supplying the printing paper, and the current status output section 722 subtracts the number of the printing paper used in printing from the remaining amount, so that the current remaining amount of the printing papers may be specified. Further, the remaining amount may be calculated by dividing the height or the weight of papers in the paper cassette by the predetermined height (thickness) or weight per one sheet (the current status output section 722 may include a height or weight sensor). Further, in the embodiment, the remaining amount of the printing papers is specified for each combination of the size and the sort of the printing paper. The size and the sort are preset for each paper cassette (not shown) storing the printing paper.

The acceptable amount of the paper discharge tray is indicative of the number of sheets of the printing paper capable of being output to the paper discharge tray (not shown). Such an acceptable amount can be specified by subtracting the current loading amount from the predetermined maximum loading amount of the paper discharge tray. The current loading amount, for example, can be calculated by dividing the height or the weight of papers within the paper discharge tray by the height (thickness) or the weight per one sheet (the current status output section 722 may include a height or weight sensor).

The remaining amount of toner for example, can be specified by using the weight of toner or electrical resistance within a toner container (the current status output section 722 can include a weight or electrical resistance sensor). Further, the remaining amount of toner may be specified by subtracting cumulative amount used of toner after a toner cartridge was replaced for the last time from the predetermined maximum toner amount corresponding to a new toner cartridge. In the embodiment, the remaining amount of toner is specified for each toner color.

The lifetime of the photoconductive drum is represented by the number of printable printing papers (total number of pages) in the embodiment. Such a lifetime can be specified by subtracting the cumulative number of printed pages after the photoconductive drum was replaced for the last time from the predetermined maximum number (maximum number of pages).

The free space of the buffer memory can be specified by referring to the job processing section 810. In the embodiment, the buffer memory is managed by the job processing section 810. However, as a method of specifying the free space, any other method can be adopted.

The determination section 830 (FIG. 2) determines whether to execute printing by using the obtained determination information DI and the resource information RI (FIG. 4). In the embodiment, when all of the five conditions mentioned below are satisfied, printing is determined to be possible. When at least one condition is not satisfied, the printing is determined not to be possible:

(C1) the remaining amount of the printing papers is more than the expected amount to be used of the printing papers required for printing;
(C2) the acceptable amount of the paper discharge tray is more than the expected amount to be used of the printing papers required for printing;
(C3) the remaining amount of toner is more than the expected amount to be used of toner required for printing.
(C4) the lifetime of the photoconductive drum is more than the expected amount to be used of the printing papers required for printing;
(C5) the free space of the buffer memory is more than the expected amount to be used of the memory required for printing.

As described above, in the embodiment, the determination section 830 determines the printing not to be possible when the printing paper, the toner, and the memory are insufficient, when the acceptable amount of the paper discharge tray is small, and when the lifetime of the photoconductive drum is exhausted. When all conditions C1 to C5 are satisfied, the determination section 830 determines the printing to be possible. And then, the determination section 830 completes the printing determination (FIG. 3: step S36c).

The prior confirmation application 250 (FIG. 2) requests confirmation of the determination status from the printer 700 after the request of the printing determination (FIG. 3: S32b, S40b). The prior confirmation application 250 transmits the job ID to the printer 700 according to this request. The print job corresponding to the printing determination is specified by the job ID.

When the request for confirmation of the determination status precedes the completion of the printing determination corresponding to the job ID (step S32b), the determination section 830 (FIG. 2) replies that confirmation is in progress (step S34c). When the request for confirmation of the determination status follows the completion of the printing determination (step S40b), the determination section 830 returns the result DR of the printing determination to the computer 100 (step S42c). This determination result DR includes information which represents printing possible (OK) or printing impossible (NG). In the embodiment, the determination result DR includes information which represents the effectuation status of each condition C1 to C5 described above. The prior confirmation application 250 can specify unsatisfied conditions by using the determination result DR.

In the next step S44b, the prior confirmation application 250 (FIG. 2) determines whether the determination result DR represents “OK”. When the determination result DR represents “OK”, the prior confirmation application 250 instructs the transmission of the job data to the spooler controller 232 in the next step S48b (third function 253). The spooler controller 232 transmits the job data to the printer 700 in accordance with instructions. In the next step S50c, the job processing section 810 executes the print operation in accordance with received the job data.

When the determination result DR represents “NG”, the prior confirmation application 250 (FIG. 2) does not supply the job data to the printer 700, but notifies the determination result DR to a user in the next step S46b (fifth function 255). As a result, print errors in the printer 700 can be suppressed. In this case, the prior confirmation application 250 may release the job ID (it may delete the setup of the job ID).

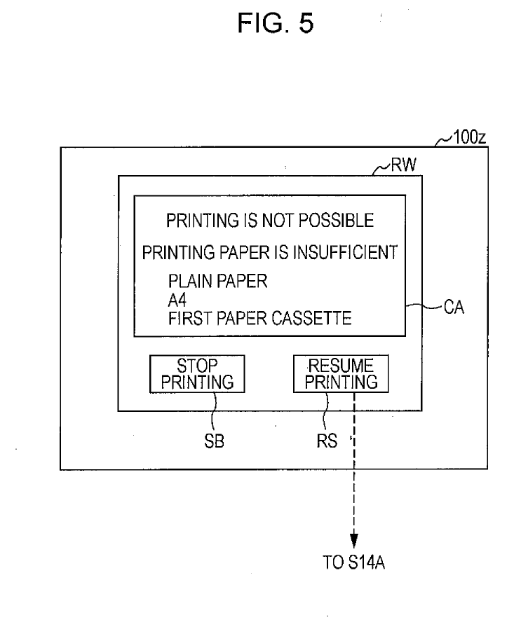

FIG. 5 is an illustrative diagram showing a window for notifying a user of the determination result DR. The prior confirmation application 250 displays this window RW to the display device 100z (FIG. 1). A message indicating that printing is not possible displays in the window RW. A user can easily confirm print processing has stopped by observing this window RW.

In addition, an unsatisfied condition (that is, the reason why printing is not possible) is displayed in the window RW. The window RW of FIG. 5 shows that the first condition C1 described above is not satisfied. When the determination result DR is “NG”, the prior confirmation application 250 preferably notifies a user of information indicative of the cause. For example, when the printing paper is insufficient, it is preferable to notify a user of the sort, the size, and the cassette number of the printing paper. Further, when toner is insufficient, it is preferable to notify a user of the color of the toner and the model number of the toner cartridge. Furthermore, when the lifetime of parts (for example, photoconductive drum) is not sufficient, it is preferable to notify a user of the names and the model numbers of these parts. This allows a user to be able to solve the matter easily.

The window RW further includes a print stop button SB and a print resuming button RS. A user print can stop printing by manipulating the print stop button SB. The prior confirmation application 250 (FIG. 2) supplies instructions for deleting the job data from the spooler 230 to the spooler controller 232 in accordance with the manipulation of the print stop button SB. The spooler controller 232 deletes the job data without transmitting them in accordance with instructions. As a result, it is possible to prevent print errors from occurring in the printer 700.

Further, a user can resume the print operation by manipulating the print resuming button RS. The cause determined as the reason why printing is not possible is displayed in the window RW. After solving the cause, a user may manipulate the print resuming button RS. For example, after supplying A4-size plain papers to the first paper cassette, a user may manipulate the print resuming button RS in an example shown in FIG. 5.

The prior confirmation application 250 (FIG. 2) returns the processing to the step S14a of FIG. 3 in accordance with the manipulation of the print resuming button RS. The prior confirmation application 250 requests the determination information DI from the driver 220. The driver 220 generates the determination information DI to supply it to the prior confirmation application 250 in response to the request. And then, processing is advanced in accordance with the procedure subsequent to the step S14a of FIG. 3. When the cause is solved, the new determination result DR shows “OK”. As a result, the print operation is performed. In addition, a jump destination of processing in response to the manipulation of the print resuming button RS is not limited to the step S14a, but an arbitrary step preceding the printing determination (S30c) can be adopted. For example, processing may be returned to the step S26b.

In the embodiment, communication between the prior confirmation application 250 (FIG. 2) and the printer 700 is controlled by the fourth function 254. Further, communication between the determination section 830 and the computer 100 is controlled by the communication processing section 820.

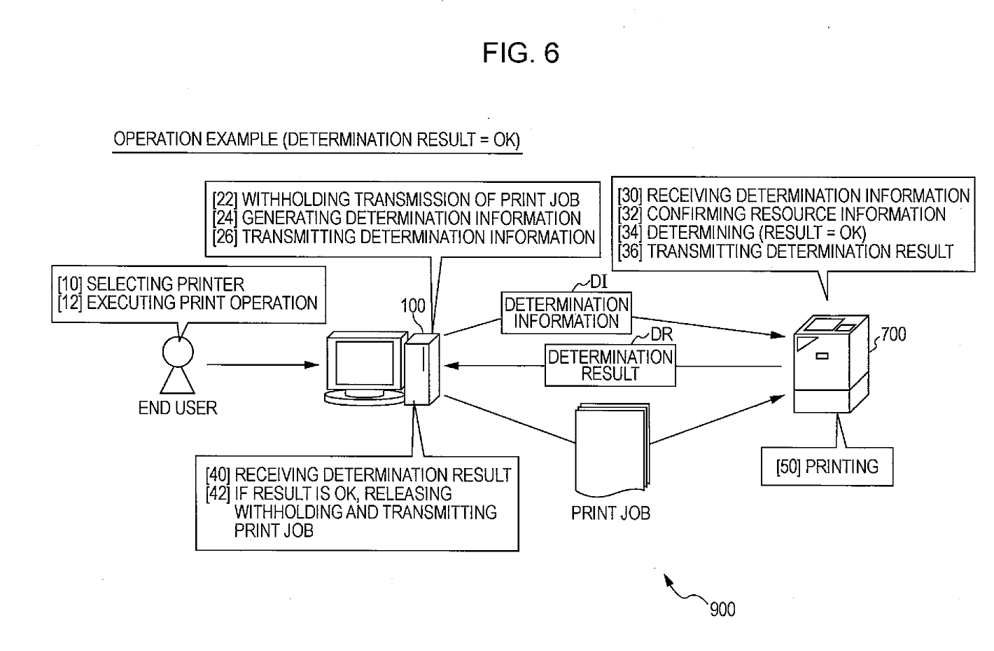

FIG. 6 is an illustrative diagram showing an operation example of the printing system 900. This operation example shows that the case where the determination result DR represented as “OK” is obtained. In FIG. 6, a portion of an operation following the sequence diagram of FIG. 3 is shown.

Further, a user selects the printer to be used in printing (operation [10]), and instructs the execution of printing (operation [12]), by manipulating the data processing application 210 (FIG. 2).

In the computer 100, the prior confirmation application 250 withholds the transmission of the job data (operation [22]). The driver 220 generates the job data, and then generates the determination information DI (operation [24]). The prior confirmation application 250 transmits the generated determination information DI to the printer 700 (operation [26]).

In the printer 700, the determination section 830 receives the determination information DI (operation [30]), and confirms the resource information RI (operation [32]). The determination section 830 then performs the printing determination (operation [34]), and transmits the determination result DR to the computer 100 (operation [36]). In an example of FIG. 6, the determination result DR is represented as “OK”.

In the computer 100, the prior confirmation application 250 receives the determination result DR (operation [40]). Since the determination result DR is represented as “OK”, the prior confirmation application 250 releases the withholding (operation [42]). The spooler controller 232 then transmits the job data to the printer 700.

The printer 700 performs the printing in accordance with the received job data (operation [50]).

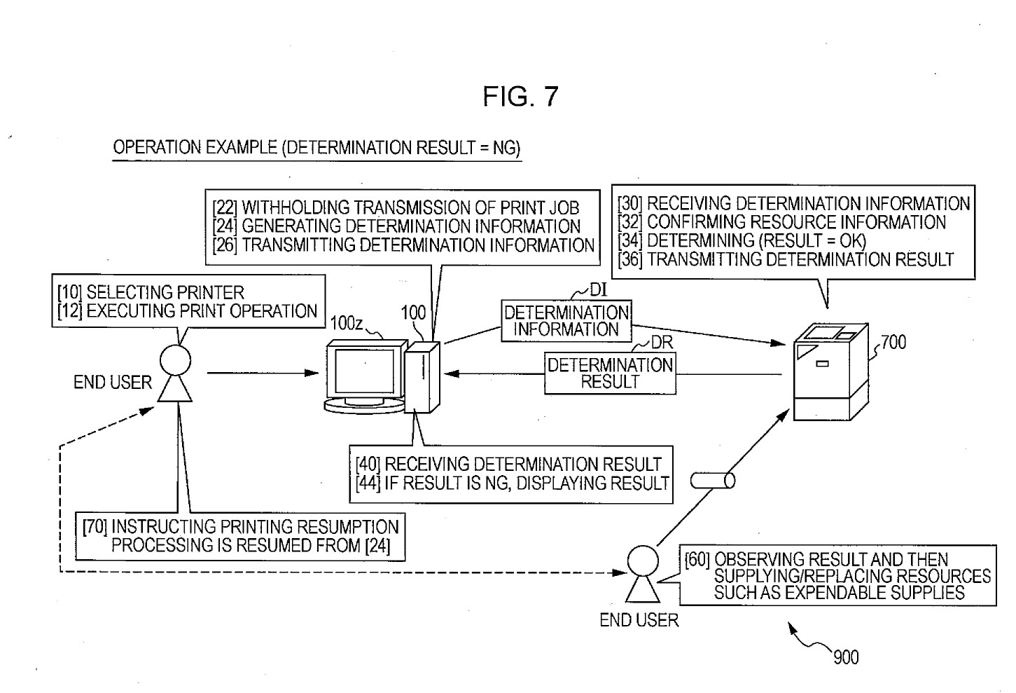

FIG. 7 is an illustrative diagram showing another operation example of the printing system 900. The difference from the operation example shown in FIG. 6 is that the determination result DR represented as “NG” is obtained. In FIG. 7, a portion of the operation following the sequence diagram of FIG. 3 is shown.

The operations [10] to [40] of FIG. 7 are equal to the operations of FIG. 6. However, the determination result DR is represented as “NG”. Since the determination result DR is represented as “NG”, the prior confirmation application 250 (FIG. 2) displays the determination result DR (window RW) to the display device 100z in the computer 100 (operation [44] of FIG. 5).

A user confirms the window RW (FIG. 5), and then supplies or replaces resources for the purpose of solving the cause (operation [60]). Subsequently, the user instructs the print resumption to the computer 100 (operation [70]). The prior confirmation application 250 resumes the print processing. When the cause is solved, a series of operations from the operation [24] of FIG. 6 are performed. When the cause is not solved, a series of operations from operation [24] of FIG. 7 are repeated.

In addition, a user may stop printing without resuming the printing. This can prevent drawbacks caused by a print error in the printer 700 from occurring.

As described above, before the job data is supplied to the printer 700, whether to execute printing is determined depending on the determination information in the embodiment. As a result, it is possible to prevent drawbacks from occurring by determining whether to execute printing to advance the printing. For example, since the reception by the printer 700 of the job data having the possibility of not being printed is suppressed, the memory size of the printer 700 does not have to be made excessively large. In addition, it is possible to prevent a print error from occurring in the printer 700. As a result, it is possible to ease the burden on the manager of the printing system 900.

In addition, since the driver 220 (FIG. 2) generating the job data generates the determination information DI as well, it is possible to prevent the configuration of the printing system 900 from becoming excessively complex. Further, in place of the driver 220, the spooler controller 232 may generate the determination information DI by analyzing the job data stored in the spooler 230. This allows the generation of the determination information DI to be performed appropriately. In this case, the spooler controller 232 is equivalent to the “determination information generation section” in the scope of claims. Further, in this case, it is possible to process the job data stored in the spooler 230. For example, two pieces of job data may be coupled and converted into one piece of job data. The spooler controller 232 may analyze the processed job data to generate the determination information DI. In addition, the spooler controller 232 may perform such a process in response to the instructions of a user.

In the embodiment, the driver 220 (FIG. 2), the spooler 230, the spooler controller 232, and the prior confirmation application 250 are entirely equivalent to the “job control section” in the scope of claims (FIG. 2). The computer 100 is equivalent to the “job control device”.

### B. Second Embodiment

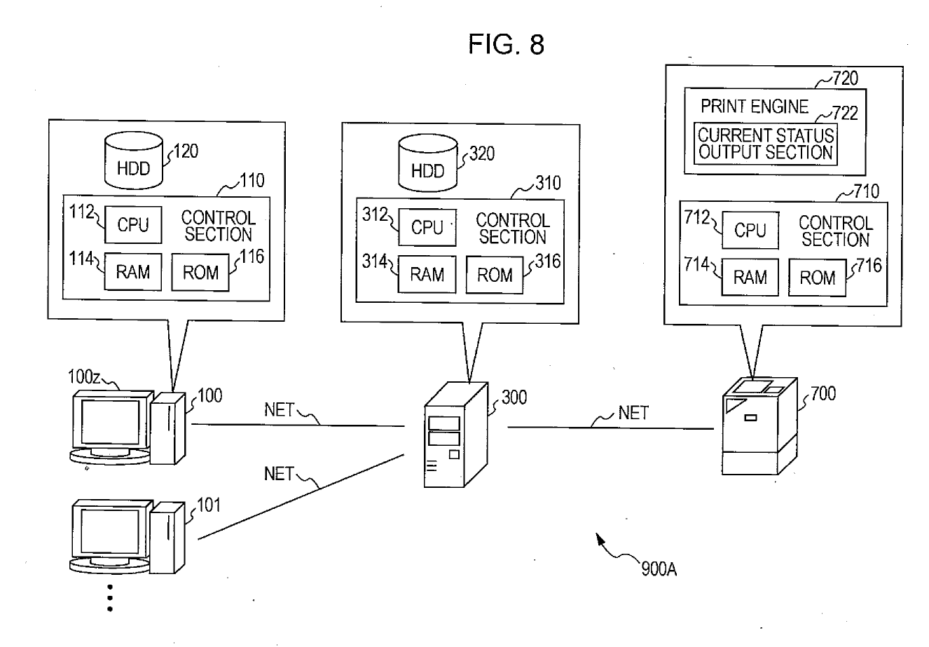

FIG. 8 is an illustrative diagram showing another embodiment of the printing system. The difference from the printing system 900 shown in FIG. 1 is that the printer 700 is commonly used in a plurality of computers (100, 101) via a print server 300. The print server 300 operates as the job control device supplying the job data to the printer 700.

The printer 700 of this embodiment is equal to the printer 700 of FIG. 1. The hardware configurations of the respective computers 100 and 101 are equal to that of the computer 100 of FIG. 1. The hardware configuration of the print server 300 is equal to that of the computer 100 of FIG. 1. The print server 300 includes a control section 310 and a hard disk drive 320. The control section 310 includes a CPU 312, a RAM 314, and a ROM 316.

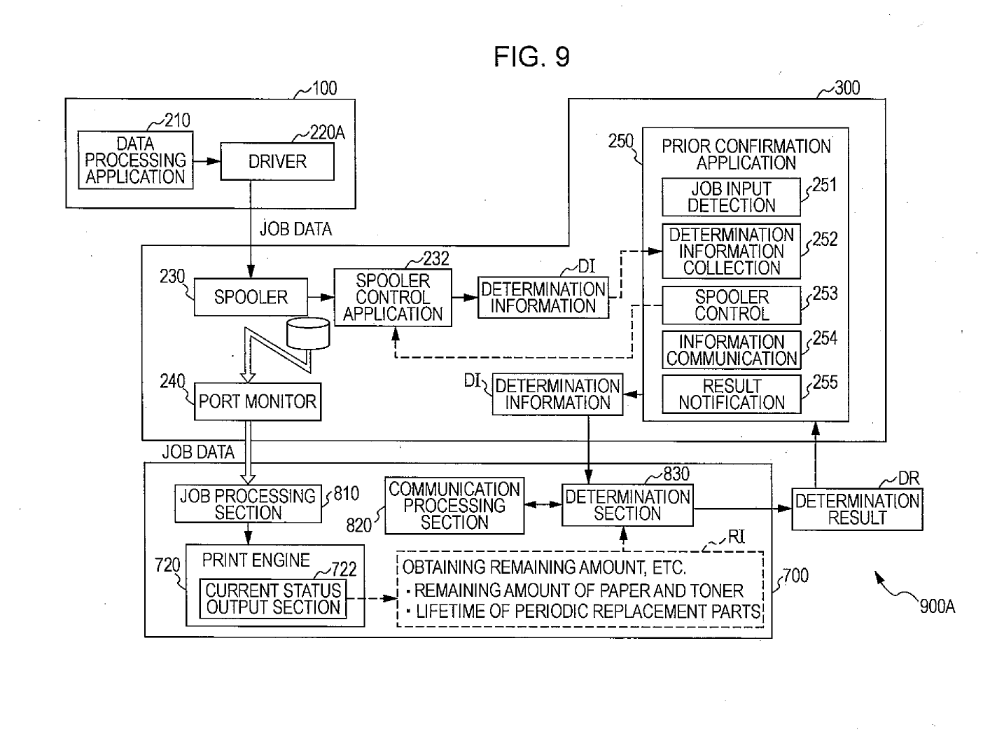

FIG. 9 is a block diagram showing the function of a printing system 900A of the embodiment. The difference from the embodiment shown in FIG. 2 is that the respective functions of the spooler 230, the port monitor 240, the spooler control application 232, and the prior confirmation application 250 are executed by the print server 300 in place of the client device (for example, computer 100). In FIG. 9, the client devices except for the computer 100 among a plurality of client devices are omitted in the drawing. However, each client device has the same driver 220A.

Even in the embodiment, the print processing is performed similarly to the embodiment shown in FIG. 3 to FIG. 5. However, the steps S12a to S16a of FIG. 3 are executed by the spooler controller 232 of the print server 300 (FIG. 9). In addition, the driver 220A of the client device 100 generates the job data similarly to the embodiment of FIG. 2 (S10a). The print controller (not shown) of the computer 100 transmits (supplies) the generated job data to the print server 300 (the supply of the job data is equivalent to the print request). The spooler controller 232 of the print server 300 stores the received job data in the spooler 230 (S12a). In addition, the spooler controller 232 generates the determination information DI by analyzing the stored job data (S14a). The spooler controller 232 then supplies the generated determination information DI to the prior confirmation application 250 (S16a).

The processing performed by the prior confirmation application 250 of the print server 300 (FIG. 9) and the printer 700 is equal to that of the embodiment shown in FIG. 3. The prior confirmation application 250 supplies the determination information DI to the printer 700, and then obtains the determination result DR from the printer 700. The prior confirmation application 250 notifies a user of the determination result DR. In the embodiment, the prior confirmation application 250 transmit notification instructions of the determination result DR to the transmission source of the job data (in the embodiment of FIG. 9, the transmission source is the computer 100). In the computer 100, the driver 220A notifies a user of the determination result DR in response to the received instructions. This notification is performed similarly to the embodiment shown in FIG. 5. The driver 220A receives instructions of a user with respect to this notification, and transmits the received instructions of a user to the print server 300. The prior confirmation application 250 executes the processing in response to instructions. In addition, the notification of the determination result DR in the computer 100 is fulfilled by a program different from the driver 220A.

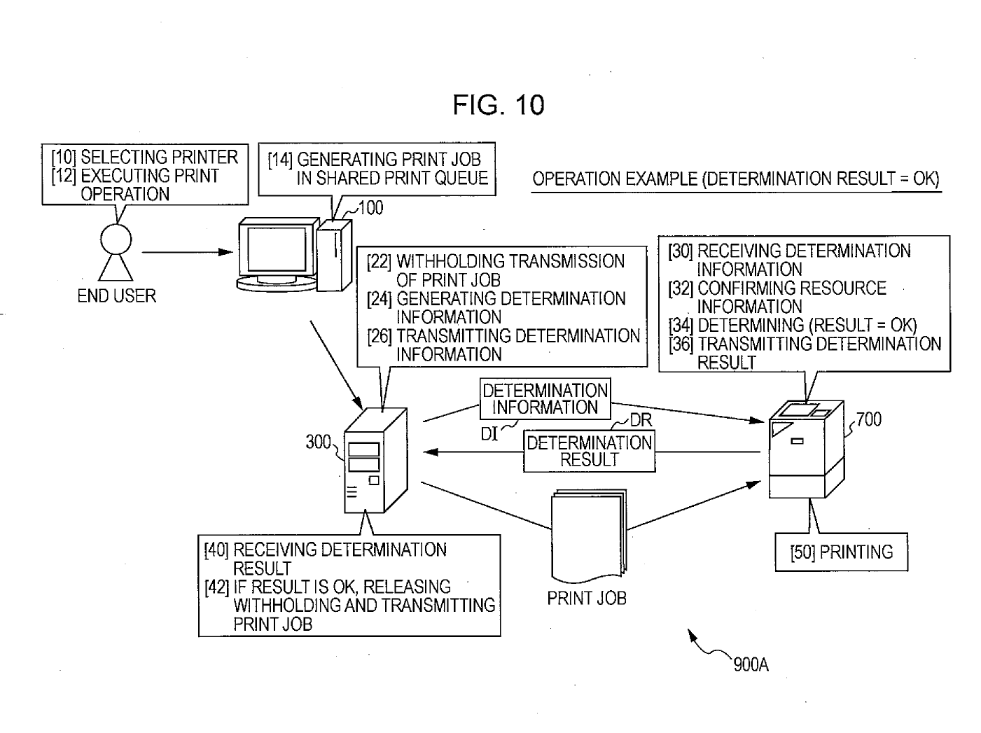

FIG. 10 is an illustrative diagram showing an operation example of the printing system 900A. An operation example of FIG. 10 shows that the case where the determination result DR is represented as “OK”, similarly to the operation example shown in FIG. 6. There are two differences from the operation example shown in FIG. 6. The first difference is that the operation [14] is added. The second difference is that the operations [22] to [26], [40], and [42] are performed by the print server 300 in place of the computer 100. In FIG. 10, the same numbers as the numbers in FIG. 6 are attached to the same operations as the operations in FIG. 6.

The operations [10] and [12] are equal to the operations [10] and [12] shown in FIG. 6. In the next operation [14], the computer 100 (driver 220A of FIG. 9) generates the job data in any of the shared print queues in response to the print request from the data processing application 210. The shared print queue is a memory which temporarily stores the job data for the shared printer 700 (for example, a portion of the storage area of the hard disk drive 320 (FIG. 8) is used as the common print queue). The print controller (not shown) of the computer 100 transmits the job data of the print queue to the print server 300.

The continuous operations [22] to [50] are equal to the operations [22] to [50] shown in FIG. 6. Herewith, the printer 700 prints an image that a user desires.

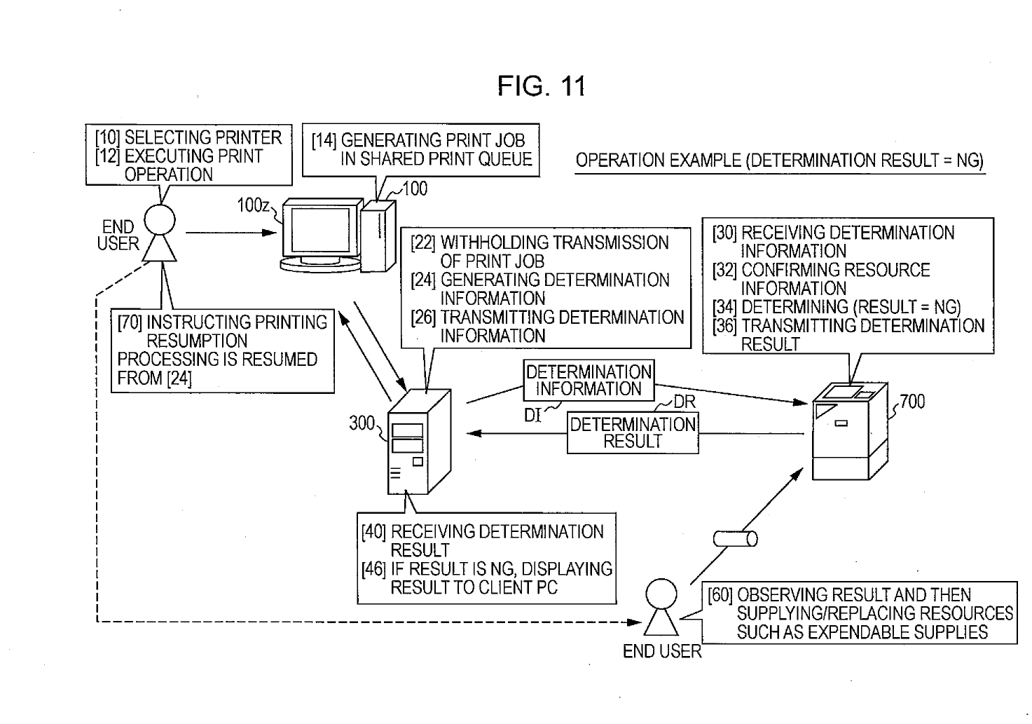

FIG. 11 is an illustrative diagram showing another operation example of the printing system 900A. The operation example of FIG. 11 shows that the case where the determination result DR is represented as “NG”, similarly to the operation example shown in FIG. 7. There are three differences from the operation example shown in FIG. 7. The first difference is that the operation [14] is added. This operation [14] is equal to the operation [14] of FIG. 10. The second difference is that the operations [22] to [26], and [40] are performed by the print server 300 in place of the computer 100. The third difference is that the operation [46] is performed in place of the operation [44] of FIG. 7. In FIG. 11, the same numbers as the numbers in FIG. 7 are attached to the same operations as the operations in FIG. 7.

The operations [10] to [40] of FIG. 11 are equal to the operations of FIG. 10. However, the determination result DR is represented as “NG”. Since the determination result DR is represented as “NG”, the prior confirmation application 250 (FIG. 9) displays the determination result DR to the computer 100 in the print server 300. In particular, the prior confirmation application 250 transmits the determination result DR to the computer 100. In the computer 100, the driver 220A notifies a user of the determination result DR. In the embodiment, the driver 220A displays the window RW similar to the embodiment shown in FIG. 5 to the display device 100z.

A user confirms the window RW (FIG. 5), and then supplies or replaces resources for the purpose of solving the cause (operation [60]). Subsequently, the user instructs the computer 100 to resume printing (operation [70]). In the computer 100, the driver 220A (FIG. 9) transmits instructions of a user to the print server 300. In the print server 300, the prior confirmation application 250 resumes the print processing. When the cause is solved, a series of operations from the operation [24] of FIG. 10 are performed. When the cause is not solved, a series of operations from operation [24] of FIG. 11 are repeated. In addition, the user may stop printing without resuming the printing.

As described above, in the embodiment, the print server 300 supplying the job data to the printer 700 in response to the determination result DR is commonly used in a plurality of client devices. That is, the print server 300 responds to each print request from the plurality of client devices, and generates the determination information DI for the print job data responding to the print request to supply the job data responding to the determination result DR. Accordingly, it is possible to prevent the configuration of each client device from becoming excessively complex. For example, the prior confirmation application 250 may not be installed in each client device.

In the embodiment, the spooler 230 (FIG. 9), the spooler controller 232, and the prior confirmation application 250 are entirely equivalent to the “job control section” in the scope of claims (FIG. 9). The print server 300 is equivalent to the “job control device”.

### C. Modified Example

In addition, elements except for elements claimed by the independent claims among components in the respective embodiments described above are additional elements, and they may be appropriately omitted. Furthermore, the invention is not limited to the described-above embodiments or examples, but can be implemented as a variety of aspects within the scope without departing from its gist. For example, the following modifications are possible as well.

### Modified Example 1

In the above-described embodiments, as the configurations of the printing system, a variety of configurations can be adopted. For example, in the embodiment shown in FIG. 2, the driver 220 does not generate the determination information DI, but the spooler controller 232 may generate the determination information DI. Further, the spooler controller 232 does not generate the determination information DI, but the driver 220 may generate the determination information DI. Furthermore, the driver 220 and the spooler controller 232 each may have functions generating the determination information DI. In this case, first of all, the driver 220 may generate the determination information DI. When the job data stored in the spooler 230 are processed, the spooler controller 232 may generate the determination information DI of the processed job data.

In the embodiment shown in FIG. 9, the printer driver may be provided in the print server 300. Further, the printer driver of the print server 300 may generate the job data in response to data received from the client device (for example, computer 100). In this case, as the data format supplied from the client device 100 to the print server 300, an arbitrary format separate from the printer 700 can be adopted. For example, so-called JPEG image data may be adopted. Further, simple text data may be adopted. The supply of data to the print server 300 by the client device 100 is equivalent to the print request.

In the embodiment shown in FIG. 9, the determination section 830 may be embedded in the print server 300. In addition, the print server 300 and the printer 700 may be embedded in one device.

### Modified Example 2

In the above-described embodiment, as the conditions of the printing determination, a variety of conditions can be adopted without being limited to the conditions shown in FIG. 4. For example, a portion of arbitrary conditions among a plurality of conditions shown in FIG. 4 may be adopted. Further, when the printer uses a paper feed roller as a periodic replacement part, if the lifetime of the roller is not sufficient, the printing may be determined not to be possible.

In general, as the condition of the printing determination, an arbitrary condition indicative of whether resources used by the printer are sufficient can be adopted. Here, resources of the printer mean the members of the printer, and include expendable supplies and the nonexpendable supplies. The expendable supplies, for example, include toner or ink or a print medium (for example, paper). The nonexpendable supplies, for example, include a variety of hardware resources such as a memory or a CPU or the paper discharge tray.

### Modified Example 3

In the above-described embodiment, as information relating to the status of the printer, a variety of information indicating the status of resources available to the printer can be adopted without being limited to the resource information RI shown in FIG. 4. For example, a portion of arbitrary information among the information shown in FIG. 4 (resource information RI) can be adopted. Further, as the information relating to the status of the printer, the remaining amount of the expendable supplies available to the printer, or the capacity of the nonexpendable supplies available to the printer may be adopted. As the remaining amount of the expendable supplies, another remaining amount of the expendable supplies can be adopted without being limited to ink or toner or the remaining amount of papers. As the capacity of the nonexpendable supplies, another capacity of the nonexpendable supplies can be adopted without being limited to the free space of the memory or the acceptable amount of the paper discharge tray.

### Modified Example 4

In the above-described embodiments, as the determination information DI, a variety of information relating to the printing of the job data can be adopted without being limited to the information shown in FIG. 4. For example, a portion of arbitrary information among information shown in FIG. 4 may be adopted. In general, as the determination information DI, a variety of information relating to resources required for printing the job data (resources of the printer) can be adopted. As such information, information relating to the capacity of the nonexpendable supplies (capacity required for printing) may be adopted. As such information, a variety of information can be adopted without being limited to the memory amount required for printing (that is, data amount), or the number of the printing paper output to the paper discharge tray. Further, as information relating to resources required for printing (resources of the printer), the expected amount to be used (expected consumption) of the expendable supplies may be adopted. As the expected amount to be used the expendable supplies, another amount to be used of the expendable supplies can be adopted without being limited to toner or ink or the amount to be used of papers. In addition, as values representing the amount of the recording material such as ink or toner, a variety of values can be adopted. For example, the physical amount representing the amount of the recording material (for example, weight or volume) may be adopted, and the dot count may be also adopted.

### Modified Example 5

In the above-described embodiments, as the procedure of the print processing, a variety of procedures can be adopted without being limited to the procedure shown in FIG. 3. In general, the determination information is generated before the job data are supplied to the printer, and whether to execute printing the job data is determined depending on the generated determination information, and information relating to the status of the printer. When the determination result shows that the printing is possible, an arbitrary procedure, such as a procedure in which the job data are supplied to the printer, can be adopted. For example, the determination section 830 (FIG. 2 and FIG. 9) may transmit the determination result DR automatically to the prior confirmation application 250 (computer 100 or print server 300) in response to the completion of the printing determination.

In addition, as the processing to be executed when the determination result DR is represented as “NG”, a variety of processes for notifying a user of the determination result can be adopted. For example, the process of turning on a lamp which indicates the determination result DR may be adopted. Further, the process of displaying the determination result DR on the display device may be adopted. Here, in addition to the determination result, it is preferable to notify a user of the cause determined as the reason why printing is not possible (for example, a lamp for indicating the cause may be turned on). This allows a user to solve the cause easily. However, the notification of the cause may be omitted.

In any case, it is preferable that the job control section (for example, prior confirmation application 250 of FIG. 2 and FIG. 9) executes the processing for notifying a user of the determination result. As processing for notifying a user of the determination result, at least one of processing for performing a notification using a notification device, and processing for transmitting instructions of a notification to equipment having a notification device can be adopted. As a notification device, for example, the above-described lamp or the display device can be adopted.

In the embodiment shown in FIG. 5, the job control section allows a user to select the processing after a notification. Here, the option may adopt another option without being limited to “print stop” and “print resuming”. Further, the job control section may execute the predetermined processing after a notification. For example, the job control section may stop printing.

### Modified Example 6

In the described-above embodiments, a portion of the configuration implemented by hardware may be replaced by software. Conversely, a portion or all of the configurations implemented by software may be replaced by hardware. For example, the function of the prior confirmation application 250 of FIG. 2 may be implemented by hardware circuits having logic circuits.

In addition, when a portion or all of the functions of the invention are implemented by software, the software (computer program) can be provided in a form stored in a computer readable recording medium. In the invention, a “computer readable recording medium” includes various types of internal storage devices within a computer such as a RAM or a ROM, or various types of external storage devices fixed to a computer such as a hard disk, without being limited to portable recording mediums such as a flexible disk or a CD-ROM.

The entire disclosure of Japanese Patent Application No. 2008-262721, filed Oct. 9, 2008 is expressly incorporated by reference herein.

What is claimed is:

1. A printing system, comprising:
a printer;
a job control section that supplies print job data to the printer; and
a determination section that determines whether to execute printing of the print job data,
wherein the job control section generates determination information, which is information relating to printing of the print job data, before the print job data are supplied to the printer,
wherein the determination section determines whether to execute printing of the print job data depending on the determination information and information relating to the status of the printer, and
wherein the job control section supplies the print job data to the printer, when the determination result shows that the printing is possible.

2. The printing system according to claim 1, wherein the job control section includes a printer driver that generates the print job data and the determination information corresponding to the print job data.

3. The printing system according to claim 1, wherein the job control section includes:
a spooler that temporarily stores the print job data; and
a determination information generation section that generates the determination information by analyzing the print job data stored in the spooler.

4. The printing system according to claim 1, further comprising a job control device which is connected to the printer and has the job control section,
wherein the determination section is provided in the printer,
wherein the job control section transmits the determination information to the printer, and
wherein the determination section transmits the determination result to the job control device.

5. The printing system according to claim 1, wherein the determination information includes at least one of:
(1) an expected amount to be used of printing papers required for the printing;
(2) an expected amount to be used of a recording material required for the printing; and
(3) an expected amount to be used of a memory required for the printing.

6. The printing system according to claim 1, wherein the information relating to the status of the printer includes at least one of:
(1) a remaining amount of the printing papers used in the printing;
(2) a remaining amount of the recording material used in the printing; and
(3) a free space of the memory used in the printing.

7. The printing system according to claim 1, further comprising a plurality of client devices,
wherein the job control section responds to each print request from the plurality of client devices, and performs generation of the determination information for print job data responding to the print request and supply of the print job data responding to the determination result.

8. The printing system according to claim 1, wherein the job control section performs processing for notifying a user of the determination result without supplying the print job data to the printer, when the determination result shows that the printing is not possible.

9. A printing method, comprising:
generating determination information, which is information relating to printing print job data, by a job control section, before the print job data are supplied to a printer;
determining whether to execute printing of the print job data by a determination section depending on the determination information and information relating to the status of the printer; and
supplying the print job data to the printer by the job control section, when the determination result shows that the printing is possible.

10. A computer readable recording medium having a program recorded thereon, the program causing the computer to execute the steps of:
generating determination information, which is information relating to printing print job data, before the print job data are supplied to a printer;
determining whether to execute printing of the print job data depending on the determination information and information relating to the status of the printer; and
supplying the print job data to the printer, when the determination result shows that the printing is possible.
